(19) United States
(12) Patent Application Publication
(10) Pub. No.: US 2018/0291760 A1
(43) Pub. Date: Oct. 11, 2018

(54) COOLING AIR CHAMBER FOR BLADE OUTER AIR SEAL

(71) Applicant: UNITED TECHNOLOGIES CORPORATION, Farmington, CT (US)

(72) Inventors: Jonathan Ortiz, El Centro, CA (US); Matthew A. Devore, Rocky Hill, CT (US); Lane Mikal Thornton, Tolland, CT (US); James D. Hill, W. Abington Twp., PA (US)

(21) Appl. No.: 15/484,166

(22) Filed: Apr. 11, 2017

(51) Int. Cl. F01D 11/20; F02C 3/04; F02C 9/18; F01D 5/02

(52) U.S. Cl. CPC F01D 11/20; F02C 3/04; F01D 15/12; F01D 5/02; F02C 9/18

(57) ABSTRACT

A gas turbine engine comprises a compressor section, a combustor, and a turbine section. The combustor has a radially outer surface defining a diffuser chamber radially outwardly of the combustor, and a cooling air chamber wall positioned outwardly of the diffuser chamber and the combustor, and radially inwardly of a second wall to define a cooling air chamber. The turbine section includes a high pressure turbine first stage blade having an outer tip, and a blade outer air seal positioned radially outwardly of the outer tip. A tap taps air having been compressed by the compressor and is passed through a heat exchanger. Air downstream of the heat exchanger passes into the cooling chamber, and then to the blade outer air seal.

### BACKGROUND OF THE INVENTION

This application relates to the supply of high pressure cooling air to a blade outer air seal through an outer diameter chamber.

Gas turbine engines are known and typically include a fan delivering air into a bypass duct as propulsion. The fan also delivers air into the compressor where air is compressed and delivered into a combustor. The air is mixed with fuel and ignited. Products of this combustion pass downstream over turbine rotors driving them to rotate. The turbine rotors, in turn, rotate compressor rotors and the fan rotor.

As can be appreciated, many components in the turbine section see very high temperatures. Two such components would be the turbine blades and blade outer air seals. Blade outer air seals typically sit radially outwardly of the blades and maintain clearance to increase the efficient use of the products of combustion.

One type of blade outer air seal is a so-called self-acting clearance control blade outer air seal. In such a blade outer air seal, two components formed of different materials having different coefficients of thermal expansion combine to control the expansion of the blade outer air seals to, in turn, control the clearance with the blade.

Both the blade and the blade outer air seal are provided with cooling air.

Traditionally, a turbine rotated at the same speed as the fan rotor. More recently, it has been proposed to include a gear reduction between a fan drive turbine and the fan rotor. With this change, the pressures and temperatures seen across the turbine sections have increased. In fact, the overall compression ratio of engines has been increasing, even in engines without a gear reduction. Again, the pressures and temperatures in the high pressure turbine sections have increased.

Thus, to drive cooling air into the turbine, the cooling air must be at a higher pressure than in the past. The highest pressure in the gas turbine engine is that downstream of a high pressure compressor. However, this cooling air is also at relatively high temperatures.

Thus, it has been proposed to tap high pressure air from a location downstream of the high pressure compressor and pass it through a heat exchanger prior to being delivered to the turbine section for cooling.

### SUMMARY OF THE INVENTION

In a featured embodiment, a gas turbine engine comprises a compressor section, a combustor, and a turbine section. The combustor has a radially outer surface defining a diffuser chamber radially outwardly of the combustor, and a cooling air chamber wall positioned outwardly of the diffuser chamber and the combustor, and radially inwardly of a second wall to define a cooling air chamber. The turbine section includes a high pressure turbine first stage blade having an outer tip, and a blade outer air seal positioned radially outwardly of the outer tip. A tap taps air having been compressed by the compressor and is passed through a heat exchanger. Air downstream of the heat exchanger passes into the cooling chamber, and then to the blade outer air seal.

In another embodiment according to the previous embodiment, the air downstream of the heat exchanger passes into a mixing chamber where it is mixed with air from the diffuser chamber, and then passes into the cooling air chamber.

In another embodiment according to any of the previous embodiments, air from the mixing chamber also passes radially inwardly of the combustor to cool the first turbine blade stage.

In another embodiment according to any of the previous embodiments, the mixing chamber is defined radially outwardly of a compressor diffuser and the air passes through vanes within the compressor diffuser.

In another embodiment according to any of the previous embodiments, the outer wall is an outer core engine wall.

In another embodiment according to any of the previous embodiments, the air is tapped from a location downstream of a downstream most point in a high pressure compressor in the compressor section.

In another embodiment according to any of the previous embodiments, the blade outer air seal includes components of at least two different materials having two distinct coefficients of thermal expansion.

In another embodiment according to any of the previous embodiments, the air is tapped from a location downstream of a downstream most point in a high pressure compressor in the compressor section.

In another embodiment according to any of the previous embodiments, the blade outer air seal includes components of at least two different materials having two distinct coefficients of thermal expansion.

In another embodiment according to any of the previous embodiments, the blade outer air seal includes components of at least two different materials having two distinct coefficients of thermal expansion.

In another embodiment according to any of the previous embodiments, the air is tapped from a location downstream of a downstream most point in a high pressure compressor in the compressor section.

In another embodiment according to any of the previous embodiments, the blade outer air seal includes components of at least two different materials having two distinct coefficients of thermal expansion.

In another embodiment according to any of the previous embodiments, the air is tapped from a location downstream of a downstream most point in a high pressure compressor in the compressor section.

In another embodiment according to any of the previous embodiments, the blade outer air seal includes components of at least two different materials having two distinct coefficients of thermal expansion.

In another embodiment according to any of the previous embodiments, the blade outer air seal includes components of at least two different materials having two distinct coefficients of thermal expansion.

In another embodiment according to any of the previous embodiments, the air is tapped from a location downstream of a downstream most point in a high pressure compressor in the compressor section.

In another embodiment according to any of the previous embodiments, the blade outer air seal includes components of at least two different materials having two distinct coefficients of thermal expansion.

In another embodiment according to any of the previous embodiments, the blade outer air seal includes components of at least two different materials having two distinct coefficients of thermal expansion.

In another embodiment according to any of the previous embodiments, a fan delivers air into the compressor section and into a bypass. A fan drive turbine of the turbine section drives the fan through a gear reduction.

In another embodiment according to any of the previous embodiments, a fan delivers air into the compressor section and into a bypass. A fan drive turbine of the turbine section drives the fan through a gear reduction.

These and other features may be best understood from the following drawings and specification.

### BRIEF DESCRIPTION OF THE DRAWINGS

FIG. 1 schematically shows a gas turbine engine.

FIG. 2 shows a detail of a cooling path.

FIG. 3 is a cross-section along line 3-3 of FIG. 2.

### DETAILED DESCRIPTION

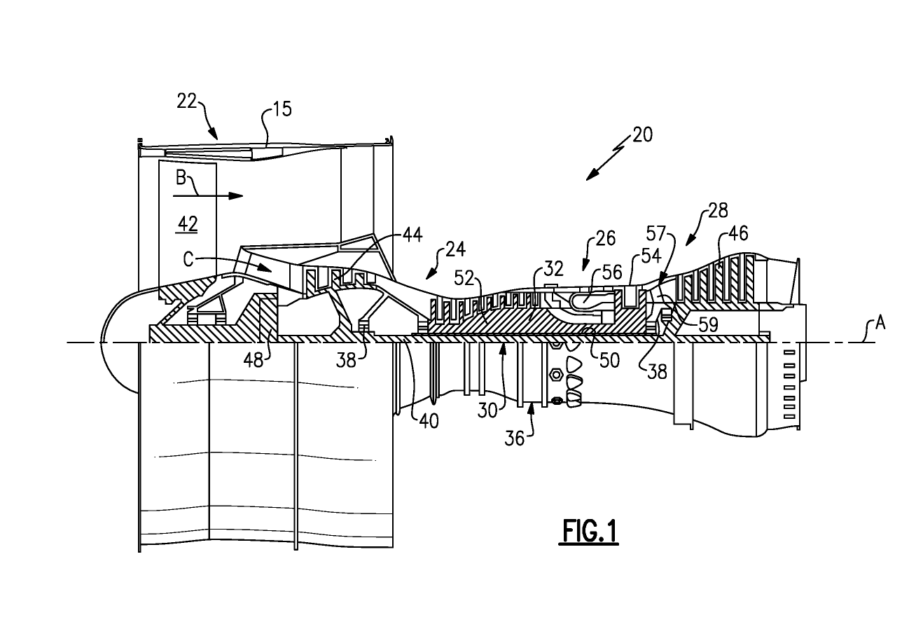

FIG. 1 schematically illustrates a gas turbine engine 20. The gas turbine engine 20 is disclosed herein as a two-spool turbofan that generally incorporates a fan section 22, a compressor section 24, a combustor section 26 and a turbine section 28. Alternative engines might include an augmentor section (not shown) among other systems or features. The fan section 22 drives air along a bypass flow path B in a bypass duct defined within a nacelle 15, and also drives air along a core flow path C for compression and communication into the combustor section 26 then expansion through the turbine section 28. Although depicted as a two-spool turbofan gas turbine engine in the disclosed non-limiting embodiment, it should be understood that the concepts described herein are not limited to use with two-spool turbofans as the teachings may be applied to other types of turbine engines including three-spool architectures.

The exemplary engine 20 generally includes a low speed spool 30 and a high speed spool 32 mounted for rotation about an engine central longitudinal axis A relative to an engine static structure 36 via several bearing systems 38. It should be understood that various bearing systems 38 at various locations may alternatively or additionally be provided, and the location of bearing systems 38 may be varied as appropriate to the application.

The low speed spool 30 generally includes an inner shaft 40 that interconnects a fan 42, a first (or low) pressure compressor 44 and a low pressure turbine 46. The inner shaft 40 is connected to the fan 42 through a speed change mechanism, which in exemplary gas turbine engine 20 is illustrated as a geared architecture 48 to drive the fan 42 at a lower speed than the low speed spool 30. The high speed spool 32 includes an outer shaft 50 that interconnects a second (or high) pressure compressor 52 and a second (or high) pressure turbine 54. A combustor 56 is arranged in exemplary gas turbine 20 between the high pressure compressor 52 and the high pressure turbine 54. A mid-turbine frame 57 of the engine static structure 36 is arranged generally between the high pressure turbine 54 and the low pressure turbine 46. The mid-turbine frame 57 further supports bearing systems 38 in the turbine section 28. The inner shaft 40 and the outer shaft 50 are concentric and rotate via bearing systems 38 about the engine central longitudinal axis A which is collinear with their longitudinal axes.

The core airflow is compressed by the low pressure compressor 44 then the high pressure compressor 52, mixed and burned with fuel in the combustor 56, then expanded over the high pressure turbine 54 and low pressure turbine 46. The mid-turbine frame 57 includes airfoils 59 which are in the core airflow path C. The turbines 46, 54 rotationally drive the respective low speed spool 30 and high speed spool 32 in response to the expansion. It will be appreciated that each of the positions of the fan section 22, compressor section 24, combustor section 26, turbine section 28, and fan drive gear system 48 may be varied. For example, gear system 48 may be located aft of combustor section 26 or even aft of turbine section 28, and fan section 22 may be positioned forward or aft of the location of gear system 48.

The engine 20 in one example is a high-bypass geared aircraft engine. In a further example, the engine 20 bypass ratio is greater than about six (6), with an example embodiment being greater than about ten (10), the geared architecture 48 is an epicyclic gear train, such as a planetary gear system or other gear system, with a gear reduction ratio of greater than about 2.3 and the low pressure turbine 46 has a pressure ratio that is greater than about five. In one disclosed embodiment, the engine 20 bypass ratio is greater than about ten (10:1), the fan diameter is significantly larger than that of the low pressure compressor 44, and the low pressure turbine 46 has a pressure ratio that is greater than about five 5:1. Low pressure turbine 46 pressure ratio is pressure measured prior to inlet of low pressure turbine 46 as related to the pressure at the outlet of the low pressure turbine 46 prior to an exhaust nozzle. The geared architecture 48 may be an epicycle gear train, such as a planetary gear system or other gear system, with a gear reduction ratio of greater than about 2.3:1. It should be understood, however, that the above parameters are only exemplary of one embodiment of a geared architecture engine and that the present invention is applicable to other gas turbine engines including direct drive turbofans.

A significant amount of thrust is provided by the bypass flow B due to the high bypass ratio. The fan section 22 of the engine 20 is designed for a particular flight condition—typically cruise at about 0.8 Mach and about 35,000 feet (10,668 meters). The flight condition of 0.8 Mach and 35,000 ft (10,668 meters), with the engine at its best fuel consumption—also known as “bucket cruise Thrust Specific Fuel Consumption (‘TSFC’)”—is the industry standard parameter of lbm of fuel being burned divided by lbf of thrust the engine produces at that minimum point. “Low fan pressure ratio” is the pressure ratio across the fan blade alone, without a Fan Exit Guide Vane (“FEGV”) system. The low fan pressure ratio as disclosed herein according to one non-limiting embodiment is less than about 1.45. “Low corrected fan tip speed” is the actual fan tip speed in ft/sec divided by an industry standard temperature correction of [(Tram °R)/(518.7°R)]^{0.5}. The “Low corrected fan tip speed” as disclosed herein according to one non-limiting embodiment is less than about 1150 ft/second (350.5 meters/second).

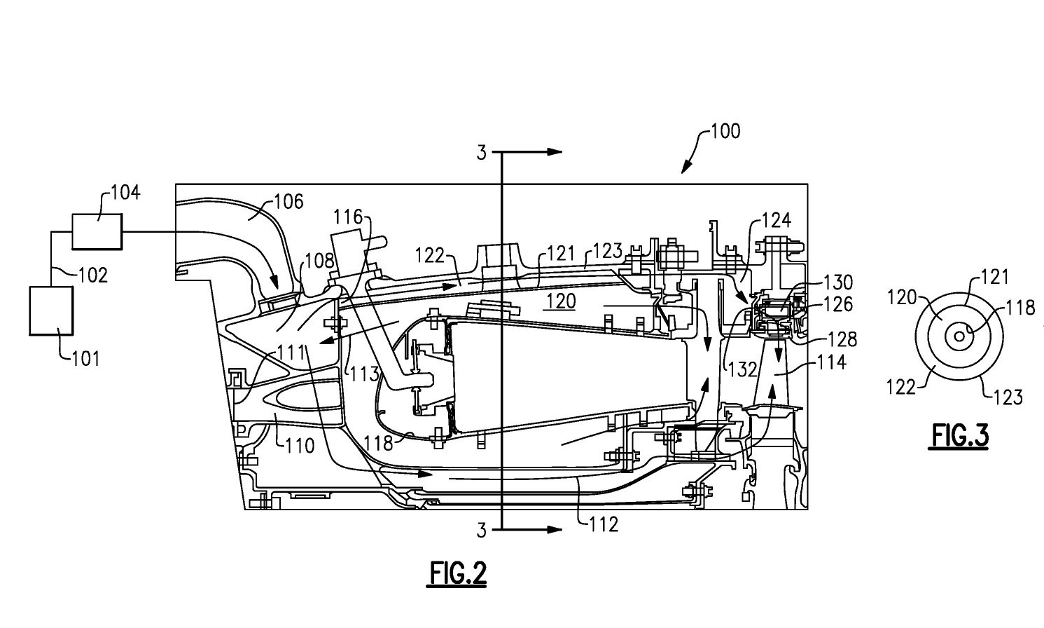

FIG. 2 shows a cooling system 100 for cooling turbine components. As shown, a compressor section 101 is provided with a tap 102 for tapping pressurized air.

The tap 102 may be at a location upstream from a downstream most portion 111 of the high pressure compressor, in which case, it is typically provided with a boost compressor to raise its pressure. Alternatively, the air can be tapped from a location downstream of 111 where it has been fully compressed by the high pressure compressor.

In either case, pressurized air passes through a heat exchanger 104 where it is cooled, such as by air. In one embodiment, the heat exchanger 104 may be in the bypass duct as described in FIG. 1.

The air downstream of the heat exchanger 104 is then returned through a conduit 106 into a mixing chamber 108. The mixing chamber 108 may be downstream of a diffuser 110 which is downstream of the downstream most portion 111 of a high pressure compressor. The air in mixing chamber 108 may be mixed with air shown schematically at 113 from a diffuser chamber 120 which surrounds a combustor 118. This air is generally at the same pressure as the air leaving the downstream most point 111.

The mixing chamber is defined radially outwardly of a compressor diffuser 110 and the air passing through vanes within the compressor diffuser.

This mixed air is shown at 112 passing to cool turbine blade 114.

Another tap 116 taps cooling air from the mixing chamber 108. This air is passed into a chamber 122 defined between a cooling air chamber wall 121 and a core engine outer housing wall 123. This air passes into another chamber 124 and across a blade outer air seal 126.

As shown, blade outer air seal 126 includes a seal 128, a first component 130, and a second component 132. The components 130 and 132 may be formed of materials having different thermal coefficients of expansion and they self-regulate a gap between an outer tip of the blade 114 and an inner surface on the seal 128.

While this particular type blade outer air seal is disclosed, it should be understood that blade outer air seals having other clearance control schemes are known, as are blade outer air seals without any clearance control. This disclosure will also benefit all of these types of blade outer air seals.

FIG. 3 shows further details including the combustor 118, the chamber 120 surrounding the combustor 118. The chamber wall 121, and the outer core housing 123 define the intermediate cooling air chamber 122. Chamber 122 surrounds a rotated axis of the engine at least about 270° and in embodiments between 350° and 360°.

Although an embodiment of this invention has been disclosed, a worker of ordinary skill in this art would recognize that certain modifications would come within the scope of this invention. For that reason, the following claims should be studied to determine the true scope and content of this invention.

1. A gas turbine engine comprising:
a compressor section, a combustor, and a turbine section, said combustor having a radially outer surface defining a diffuser chamber radially outwardly of said combustor, and a cooling air chamber wall positioned outwardly of said diffuser chamber and said combustor, and radially inwardly of a second wall to define a cooling air chamber;
said turbine section including a high pressure turbine first stage blade having an outer tip, and a blade outer air seal positioned radially outwardly of said outer tip; and
a tap for tapping air having been compressed by said compressor and being passed through a heat exchanger, air downstream of said heat exchanger passing into said cooling chamber, and then to said blade outer air seal.

2. The gas turbine engine as set forth in claim 1, wherein said air downstream of said heat exchanger passes into a mixing chamber where it is mixed with air from said diffuser chamber, and then passes into said cooling air chamber.

3. The gas turbine engine as set forth in claim 2, wherein air from said mixing chamber also passing radially inwardly of said combustor to cool said first turbine blade stage.

4. The gas turbine engine as set forth in claim 3, wherein said mixing chamber defined radially outwardly of a compressor diffuser and the air passing through vanes within said compressor diffuser.

5. The gas turbine engine as set forth in claim 4, wherein said outer wall is an outer core engine wall.

6. The gas turbine engine as set forth in claim 5, wherein said air is tapped from a location downstream of a downstream most point in a high pressure compressor in said compressor section.

7. The gas turbine engine as set forth in claim 6, wherein said blade outer air seal includes components of at least two different materials having two distinct coefficients of thermal expansion.

8. The gas turbine engine as set forth in claim 4, wherein said air is tapped from a location downstream of a downstream most point in a high pressure compressor in said compressor section.

9. The gas turbine engine as set forth in claim 8, wherein said blade outer air seal includes components of at least two different materials having two distinct coefficients of thermal expansion.

10. The gas turbine engine as set forth in claim 4, wherein said blade outer air seal includes components of at least two different materials having two distinct coefficients of thermal expansion.

11. The gas turbine engine as set forth in claim 3, wherein said air is tapped from a location downstream of a downstream most point in a high pressure compressor in said compressor section.

12. The gas turbine engine as set forth in claim 11, wherein said blade outer air seal includes components of at least two different materials having two distinct coefficients of thermal expansion.

13. The gas turbine engine as set forth in claim 2, wherein said air is tapped from a location downstream of a downstream most point in a high pressure compressor in said compressor section.

14. The gas turbine engine as set forth in claim 13, wherein said blade outer air seal includes components of at least two different materials having two distinct coefficients of thermal expansion.

15. The gas turbine engine as set forth in claim 2, wherein said blade outer air seal includes components of at least two different materials having two distinct coefficients of thermal expansion.

16. The gas turbine engine as set forth in claim 1, wherein said air is tapped from a location downstream of a downstream most point in a high pressure compressor in said compressor section.

17. The gas turbine engine as set forth in claim 16, wherein said blade outer air seal includes components of at least two different materials having two distinct coefficients of thermal expansion.

18. The gas turbine engine as set forth in claim 1, wherein said blade outer air seal includes components of at least two different materials having two distinct coefficients of thermal expansion.

19. The gas turbine engine as set forth in claim 18, wherein a fan delivers air into said compressor section and into a bypass, and a fan drive turbine of said turbine section driving said fan through a gear reduction.

20. The gas turbine engine as set forth in claim 1, wherein a fan delivers air into said compressor section and into a bypass, and a fan drive turbine of said turbine section driving said fan through a gear reduction.
